(19) United States
(12) Patent Application Publication
(10) Pub. No.: US 2008/0081756 A1
(43) Pub. Date: Apr. 3, 2008

(54) Thermally Insulating Glass Material Functioning as a Capillary Water Suction Barrier and Method for its Manufacture

(75) Inventors: Harald Sathre, Jona (CH); Arvid Sorvik, Stjordal (NO)

Correspondence Address: DENNISON, SCHULTZ & MACDONALD, 1727 KING STREET, SUITE 105, ALEXANDRIA, VA, 22314, US

(73) Assignee: HAS HOLDING AS, Trondheim (NO)

(21) Appl. No.: 11/813,486

(22) PCT Filed: Jan. 18, 2006
(86) PCT No.: PCT/NO06/00024

§ 371 Date: Oct. 10, 2007

(30) Foreign Application Priority Data
Jan. 20, 2005 (NO) 20050319

(51) Int. Cl. C03B 19/08; C03C 11/00

(52) U.S. Cl. 501/39; 65/22

(57) ABSTRACT

Thermally insulating recycle glass material functioning as a capillary water suction barrier and method for its manufacture. The glass raw material (2, 3) contains impurities from the group comprising ceramics, porcelain, stone, plastic, and paper, in the presence of an activator to facilitate foaming of the glass. The method comprises at least two steps, namely a preheating step (8) in which the raw material is heated to a temperature in the range 500-700 ° C. to reduce the amount of detrimental contaminations and a foaming step (9) in which the material is heated to a temperature in the range 900-980 ° C. in which the glass is foamed and forms a structure of closed pores. Impurities/ contaminations can be present in an amount of up to 10% by weight of the glass. Preferably the method comprises a tempering step (7) prior to the preheating step (8).

The present invention concerns a method for the manufacture of a thermally insulating glass material functioning as a capillary water suction barrier and more particularly from recycle glass containing contaminations of ceramics, porcelain, stone (CPS) and possibly organic materials, plastic and paper. According to another aspect the invention concerns an insulating material manufactured by such method.

### BACKGROUND

It is a desire and a requirement to be able to recycle glass materials of different types to the largest extent possible to prevent it to be accumulated in land fills or dumpsites. At the same time there is a high requirement of lightweight insulating materials in the industry with capillary water suction barrier properties.

Furthermore it is well known in the art that glass may be used as an insulating material after heating and foaming under formation of a very lightweight and comparatively strong structure of closed pores separated by thin walls. It is however only certain types of glass that has proven adequate for the purpose and the foaming process is sensitive to impurities in the glass. It is therefore required with a high degree of separation between different qualities of glass and a correspondingly high degree of purification of the glass with respect to impurities to ensure that the foaming process may be conducted in a problem free manner.

A process according to prior art technology is described in EP 0 292 424 B1. If, according to the process of this publication, lamp glass is included, which typically contains difficultly fusible glass in combination with foamed elements from glue, bakelite, plastic etc., in an amount exceeding 5% by weight, the process will not run as desired, as the foaming will be insufficient and uncontrollable and lead to formation of large, irregular pores and unreacted glass powder in the manufactured product.

### OBJECTIVES

It is thus an objective of the present invention to provide a method for the manufacture of a lightweight, capillary water suction barrier insulating material from recycle glass, which is less sensitive to impurities in the form of ceramics, porcelain, stone, plastic, paper, organic materials, and moisture than prior art methods. It is furthermore an object to provide a process that is less sensitive than prior art methods with respect to choice of glass materials, so that glass with a higher degree of variation in composition and cleanness may be used than with prior art methods while maintaining or improving the product quality and material properties.

### THE PRESENT INVENTION

The mentioned objectives are according to the present invention fulfilled by a method as defined by claim 1. According to another aspect the present invention concerns an insulating material as defined by claim 19.

Preferred embodiments of the invention are disclosed by the dependent claims.

According to the method of the present invention crushed recycle glass is subjected to a first step of treatment at a temperature in the range 500-700° C. In this step impurities in the form of calcium carbonates, hydrocarbons like plastic materials, paper, moisture etc. are evaporated or otherwise removed from the reaction mixture. Injection of air into the preheating zone of the oven increases the efficiency with respect to removal of such impurities as air facilitates combustion of combustible components. Air enriched with oxygen may provide a further increase in efficiency if desired.

In a subsequent step of treatment the glass is foamed and to achieve foaming the temperature must reach at least 900° C. In its simplest form this second step of treatment is equal to the treatment according to prior art technology.

The glass used as raw material according to the present method can comprise glass from many different sources and will typically comprise glass chosen among window glass, laminated glass (white glass), lamp glass, ceramic glass, CRT glass (used e.g. as front glass in TV screens), toughened glass and packaging glass. Packaging glass (bottle glass) should be present in an amount of at least 20% by weight of the total weight of the glass.

The temperature of the second step of treatment is chosen or adapted to the composition of the recycle glass in question. If there is a high content of lamp glass and/or ceramic glass it is required with a somewhat higher temperature in the second treatment step. If the relative amount of said types of glass is between 20 and 50% by weight a temperature in the range between 950 and 980° C. will normally be required in the second step. If the relative amount of lamp glass and/ or ceramic glass is between 5 and 20% by weight a temperature in the range between 935 and 950° C. will be sufficient in the second step. If the relative amount of lamp glass and/or ceramic glass is 5% by weight as a maximum, a temperature in the range 900 and 935° C. will be sufficient in the second step.

It is preferable to run the process as efficiently and inexpensive as possible. It has been discovered that there is a relation between the fineness of the particles and the required retention time in each of the zones. A typical retention time in the first treatment zone is within the range 4 to 10 minutes while a typical retention time in the second step is within the range 3 to 7 minutes. In general the retention time is somewhat longer in the preheating zone than in the foaming zone, typically at least one minute longer.

To achieve a desired product with as short retention times as indicated above it is required with a comparatively high degree of comminution of the glass material. It is thus preferred that the glass is comminuted in a manner known per se until the mean grain size, defined as Gd₅₀, is 35 μm or less.

It is furthermore preferred that the so-called activator which typically is comprised by or comprises SiC, is grounded to a grain size defined by Ad₅₀ being 10 μm or less. While SiC is a preferred activator it may be at least partially replaced by filter ash from wood processing industry, comminuted to the same grain size as the SiC activator. The advantage of the filter ash is that it is inexpensive as it represents waste from another industry.

A suitable activator mixture may comprise up to 40% by weight filter ash and at least 60% by weight SiC. The activator is typically present in an amount of 0.75-2.0% by weight of the glass and more preferred in an amount of about 1.5%.

While the process mandatory comprises two steps of treatment as described above, it may conveniently include also a third treatment step that chronological is the first one and may be referred to as a pre-treatment. In the pre-treatment the material is heated to a more moderate temperature than treatment step one and typically to temperature in the range 200-400° C. This pre-treatment may also be denoted as a tempering as one of its purposes is to reduce the time required to bring the temperature up to required temperature in the subsequent treatment step one. A further purpose of the tempering step is to eliminate the most volatile contaminations such as remains of plastic and paper already before the material is subjected to treatment in step one.

What is particularly achieved by the method according to the present invention is as mentioned the possibility to use glass compositions of a more varied origin without jeopardizing the process. In addition a lower sensitivity or vulnerability to impurities in general is obtained, as these are largely eliminated prior to the foaming step. The highest amount of CPS type contaminations that the process has been used for until now is about 10% by weight of the glass material, and the process yielded a fully satisfying insulating material.

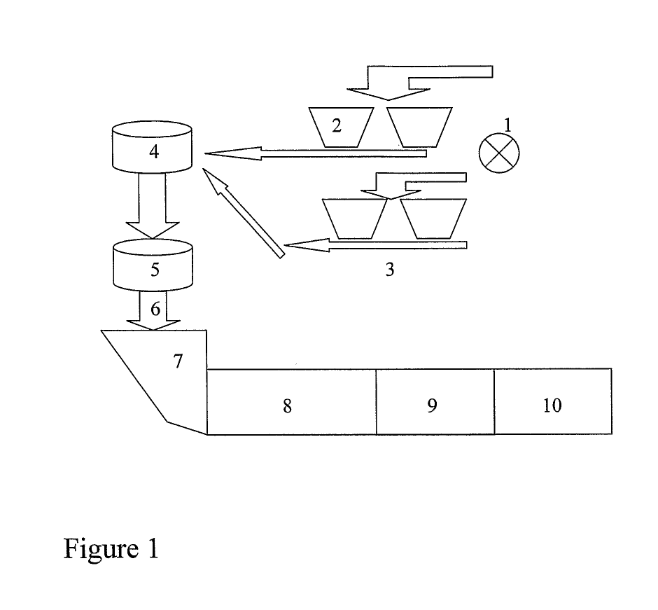

Below a preferred embodiment of the process is described with reference to the accompanying FIG. 1, which schematically illustrates the separate steps of the process.

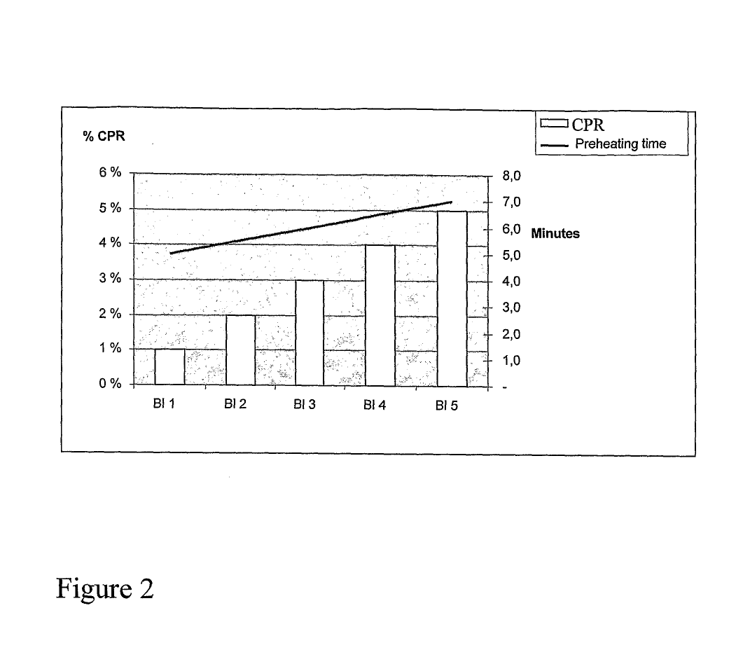

FIG. 2 shows retention times in the preheating step as function of relative amount (portion) of CPS type contaminations in the supplied glass material.

In a grounding station 1 glass of different quality and origin is comminuted and temporarily stored separate from glass of other qualities and origin. Then the ground glass is weighed in weighing stations 2 and 3 to certain amounts/rates according to its type and quality and mixed with other glass particles in a grounding station 4 in which the glass particles are finely comminuted to the final desired grain size. From here the comminuted glass is transferred to a container 5 in which a controlled amount of activator is added to the comminuted glass and mixed until the composition is homogenous. From container 5 the activated glass is transferred batchwise or continuously in a material flow 6 to a tempering zone 7 in which the glass is warmed (tempered) to a temperature of up to 400° C. From the tempering zone the tempered glass is transferred to the preheating zone 8 in which it is heated further to a temperature in the range 500-700° C. The glass is typically kept in this zone for about 4 to 10 minutes. The last active step of the process is the foaming zone 9 to which the glass is fed from the preheating zone and heated further to a temperature between 900 and 1000° C. somewhat dependent upon the glass composition. The retention time in this zone is about 3 to 7 minutes. Finally the glass is discharged from the foaming zone and into a cooling zone in which the glass is allowed to cool to a temperature below 900° C. at first and thereafter to a temperature not higher than 300-400° C.

The progress in each step may shortly be summarized as follows.

Tempering

During tempering 7 the most volatile, oxidizable, or combustible contaminations are removed from the composition, such as paper and plastics. In addition this step contributes to shorten the period in the preheating step since the raw material is already at a comparatively high temperature when it is fed to the preheating step.

Preheating

The preheating 8 eliminates by evaporation or otherwise contaminations such as ceramics, porcelain, and stone (CPS) that contains materials that may function as foaming activators at an undesired low temperature and thereby detrimentally affect the quality of the final product if present in the foaming step.

Foaming

In the foaming zone 9 the glass powder and the present activator are “foamed” under formation of a porous structure of glass and closed pores with a porosity typically in the range 65-87% and with a density in the range 215-580 kg/ m³. The foamed glass typically has a compressive strength in the range 3-13 N/mm² and provides a capillary water suction barrier, i.e. that it does not tend to suck up any water that it might be contacted with.

As evident from FIG. 2 the retention time in the preheating step must be somewhat increased with increased portion CPS type contamination in the glass. It is, however, not necessary with a proportional increase of the retention time. When the CPS content is 1% a suitable retention time is found to be 5 minutes. If the CPS content (the portion) is increased to 5%, i.e. an increase of 400%, the required retention time is found to be about 7 minutes, i.e. a 40% increase.

For typical use the foamed glass is fragmented to pieces with a 10-60 mm size that is useful as insulation in many applications, such as insulation around foundation walls, under concrete floors, under road pavement, in plant nurseries, in floors on ground, as a lightweight filler in constructions on weak grounds, behind supporting walls, for road constructions on weak grounds, behind bridge piers, as a filler in biological water purification plants, as a lightweight aggregate in concrete etc.

1. Method for the manufacture of a thermally insulating glass material functioning as a capillary water suction barrier from recycle glass containing impurities from the group comprising ceramics, porcelain, stone, plastic, and paper, in the presence of an activator to facilitate foaming of the glass, characterized in that the method comprises at least two steps, namely a preheating step in which the raw material is heated to a temperature in the range 500-700° C. to reduce the amount of detrimental contaminations and a foaming step in which the material is heated to a temperature in the range 900-980° C., in which the glass is foamed and forms a structure of closed pores.

2. Method as claimed in claim 1, characterized in that air is injected into the preheating zone of the oven.

3. Method as claimed in claim 1, characterized in that oxygen enriched air is injected into the preheating zone of the oven.

4. Method as claimed in claim 1, characterized in that the glass comprises glass chosen among window glass, laminated glass (white glass), lamp glass, ceramic glass, CRT glass, toughened glass and packaging glass (bottle glass), the packaging glass comprising at least 20% by weight of the glass material.

5. Method as claimed in claim 1, characterized in that the glass is comminuted to grain size defined by Gd⁵⁰ being less than 35 μm.

6. Method as claimed in claim 1, characterized in that the activator comprises SiC.

7. Method as claimed in claim 1, characterized in that the activator is comprised by a mixture of SiC and filter ash from combustion of wood and other biologic material, said filter ash comprising up to 40% by weight of said mixture.

8. Method as claimed in claim 1, characterized in that the activator is comminuted to a grain size defined by Ad₅₀ is less than 10 μm.

9. Method as claimed in claim 1, characterized in that the activator is present in an amount of 0.75-2.0% by weight of the glass.

10. Method as claimed in claim 1, characterized in that the activator is present in an amount of about 1% by weight of the glass.

11. Method as claimed in claim 1, characterized in that the method comprises three steps, as a tempering step in which the raw material is warmed to a temperature between 200° C. and 400° C. is included prior to the preheating step.

12. Method as claimed in claim 1, characterized in that the retention time of the raw material is in the range 4-10 minutes in the preheating step.

13. Method as claimed in claim 1, characterized in that the retention time of the raw material is in the range 3-7 minutes in the foaming step.

14. Method as claimed in claim 1, characterized in that the raw material has a retention time in the preheating step that is at least one minute longer than the retention time in the foaming step.

15. Method as claimed in claim 1, characterized in that the temperature in the foaming step is in the range 900-935° C. when the content of lamp glass plus ceramic glass constitutes less than 5% by weight of the raw material.

16. Method as claimed in claim 1, characterized in that the temperature in the foaming step is in the range 935-950° C. when the content of lamp glass plus ceramic glass constitutes between 5 and 20% by weight of the raw material.

17. Method as claimed in claim 1, characterized in that the temperature in the foaming step is in the range 950-980° C. when the content of lamp glass plus ceramic glass constitutes between 20 and 50% by weight of the raw material.

18. Method as claimed in claim 1, characterized in that the content of CPS type contaminations comprises up to 10% by weight of the glass, preferably between 4 and 10%.

19. Thermally insulating foamed glass functioning as a capillary water suction barrier produced from recycle glass containing impurities from the group comprised by ceramics, porcelain, stone, plastic, and paper in the presence of an activator to facilitate foaming of the glass, characterized in that it is manufactured in accordance with claim 1.
